(19) United States
(12) Patent Application Publication
(10) Pub. No.: US 2004/0241258 A1
(43) Pub. Date: Dec. 2, 2004

(54) Insect repellent for humans and animals

(76) Inventor: Jack W. Mentkow, Wellington, FL (US)

Correspondence Address: JACK MENTKOW, 1875 TULIP LANE, WELLINGTON, FL, 33414, US

(21) Appl. No.: 10/447,911

(22) Filed: May 28, 2003

(51) Int. Cl. A01N 25/00

(52) U.S. Cl. 424/745; 424/764

(57) ABSTRACT

A natural insect repellent composition containing eucalyptus citriodora oil, citronella oil, lemongrass oil, and pennyroyal oil in synergistic amounts designed to increase its potency and extend its period of efficacy. A method for applying said formulation to skin and clothing.

### REFERENCES CITED

### U.S. Patent Documents

| | | | |
|---|---|---|---|
| 4671960 | Jun., 1987 | Thielen, et al. | 424/405 |
| 5165932 | Nov., 1992 | Horvath | 424/195 |
| 5106622 | Apr., 1992 | Sherwood, et al. | 424/195 |
| 5208029 | May, 1993 | Plummer, et al. | 424/195 |
| 5466458 | Nov., 1995 | Wilson | 424/407 |
| 5776477 | Jul., 1998 | Ryder | 424/405 |
| 6300324 | Oct., 2001 | Partelow | 514/78 |
| 20030026823 | Feb., 2003 | Fried, et al. | 424/405 |
| 20030083387 | May, 2003 | Roe | 5148675 |

### BACKGROUND OF THE INVENTION

Currently, most commercial insect repellents contain the chemical N, N-diethyl-meta-toulamide (DEET) as the active ingredient. DEET is a neurotoxin which has been found to remain in the blood stream for 30 days after its use by subjects as an insect repellent. As a result, the Environmental Protection Agency (EPA) has banned claims by manufacturers of DEET products that they are “safe for children”. Adults, too, are subject to rashes, seizures and irritability even when using DEET product as directed.

It is important to distinguish between insecticides and repellents. Insecticides are designed to kill insects and as such are toxic to humans. Insecticides because of their toxicity, must be registered with the Environmental Protection Agency (EPA). Many are not biodegradable and some (DDT, Alar) have even been banned from use due to their harmful ecological and carcinogenic effects.

Repellents, on the other hand, are defined as substances that cause insects to turn away or avoid the treated subject. There are many compositions that are known to have varying degrees of repellency for limited periods of time.

Accordingly, there is currently an absence in the marketplace of a commercially available natural, biodegradable, long lasting insect repellent.

### SUMMARY OF THE INVENTION

Accordingly, it is an object of the present invention to provide a natural insect repellent free of DEET and other toxic or irritating, synthetic chemicals which is completely effective.

Another object of the present invention is to provide a natural insect repellent which is effective for extended periods of time.

A further object of the present invention is to provide a natural insect repellent which is safe for use by adults and children.

A further object of the present invention is to provide a natural insect repellent which is biodegradable and therefore environmentally safe and friendly.

A further object of the present invention is to provide a natural insect repellent which is easy to use, may be applied to both skin, fur, and clothing, and economical to manufacture from readily available ingredients.

The foregoing and other objects of the invention are obtained by the use of an insect repellent, wherein the active ingredients are eucalyptus citriodora oil, citronella oil, lemongrass oil, and pennyroyal oil. Combining these essential oils creates a synergistic rather than additive effect when used in the appropriate relative concentrations and provides a natural insect repellent that is completely effective for extended periods of time.

### DESCRIPTION OF THE PREFERRED EMBODIMENTS

In accordance with the specification of the present invention, the preferred embodiment of this invention as an insect repellent for humans that may be applied to skin and clothing is produced by combining the active ingredients eucalyptus citriodora oil, citronella oil, lemongrass oil, and pennyroyal oil in an inert medium of ethyl alcohol in accordance with the following Table #1

TABLE #1

| Ingredient | Amount (by weight) |
|---|---|
| Eucalyptus Citriodora | 20% |
| Lemongrass oil | 1% |
| Citronella oil | 1% |
| Pennyroyal oil | 1% |
| Ethyl alcohol | 77% |

The oil of eucalyptus utilized in the composition is a volatile oil extracted from the fresh leaves of a specific eucalyptus specie (citriodora). Although there are more than 100 varieties of eucalyptus, only eucalyptus citriodora has been found to produce the desired results when combined with the other active ingredients of the composition. Eucalyptus citriodora, when used by itself, was found to be limited in potency, effectiveness, and duration as an insect repellent.

The composition of the present invention is easily formulated. The inert medium utilized in the composition of the invention is ethyl alcohol (190°—200°) which allows the active ingredients (essential oils), once added to it, to solubalize requiring no shaking or mixing prior to use and which allows for easy application using a mist sprayer dispenser bottle providing complete coverage on exposed skin and clothing. The ethyl alcohol flashes (evaporates) almost on contact leaving only the active ingredients composition as a thin completely effective insect repellent coverage for the subject.

The inert medium utilized in the composition of the present invention will depend upon the particular use or application of the composition. The present invention's inert medium includes but is not limited to petrolatum, paraffin wax and mixtures thereof, aqueous emulsions, soaps, oleaginous materials or impregnated in natural fibers such as cotton rope or cord.

The preferred embodiment of the present invention is heretofore described in detail but it should be understood that various other modifications can be effected an still be within the spirit and scope of the invention. The exact amount or ratio of each ingredient may be varied without departing from the spirit of this invention. For example, other ingredients may be incorporated in the formulation provided they do not have a deleterious effect on the performance characteristics of the composition of the invention. It may be desirable in some applications to change the odor, color, viscosity or other aspects of the composition. In addition, the inert vehicle may be different to meet specific requirements, e.g., a powder. Therefore, the scope of the invention is to be limited only by the preceding claims.

To further illustrate the present invention, the following testing which had been carried out in various subjects is presented below. In each case, a screened test cage with dimensions of 2′×2′×2′ with a cloth stocking access port for the insertion of an arm was used. Two hundred to three hundred 4 to 5 day old adult mosquitoes of varying species (noted below) were introduced into the cage in the experiments and were not blood-fed prior to the experiments to increase their aggressiveness. In each case the subject's other bare untreated arm was used as a control to validate the results of the present invention by first introducing it into the cage and receiving two or more bites within the first two minutes.

Case #1

The subject (#1) male's arm was treated with the invention prior to insertion into the test cage of mosquitoes (Culex Pipiens). The subject tested the efficacy of the invention over an eight hour period for ten minutes at half-hour intervals. The subject male received no bites over the eight hour period.

Case #2

The subject (#2) female's arm was treated with the invention prior to insertion into the test cage of mosquitoes (Culex Pipiens). The subject tested the efficacy of the invention over an eight hour period for ten minutes at half-hour intervals. The subject male received no bites over the eight hour period.

Case #3

The subject (#3) male's arm was treated with the invention prior to insertion into the test cage of mosquitoes (Culex Pipiens). The subject tested the efficacy of the invention over an eight hour period for ten minutes at half-hour intervals. The subject male received no bites over the eight hour period.

Case #4

The subject (#1) male's arm was treated with the invention prior to insertion into the test cage of mosquitoes (Culex Quinquefaxciatus). The subject tested the efficacy of the invention over an eight hour period for ten minutes at half-hour intervals. The subject male received no bites over the eight hour period.

Case #5

The subject (#2) female's arm was treated with the invention prior to insertion into the test cage of mosquitoes (Culex Quinquefaxciatus). The subject tested the efficacy of the invention over an eight hour period for ten minutes at half-hour intervals. The subject male received no bites over the eight hour period.

Case #6

The subject (#3) male's arm was treated with the invention prior to insertion into the test cage of mosquitoes (Culex Quinquefaxciatus). The subject tested the efficacy of the invention over an eight hour period for ten minutes at half-hour intervals. The subject male received no bites over the eight hour period.

What is claimed is:

1. A natural, biodegradable insect repellent composition comprising active ingredients: eucalyptus citriodora oil, citronella oil, lemongrass oil, and pennyroyal oil; and wherein said insect group includes but is not limited to mosquitoes, ticks, gnats, deer flies, no-see-ums, thrips, aphids, and fleas.

2. A method according to claim 1, wherein said compound is applied to the skin and/or clothing of the subject.

3. An insect repellent composition according to claim 1, wherein the primary active ingredient is eucalyptus citriodora and wherein the synergists are citronella oil, lemongrass oil, and pennyroyal oil used individually or in combination.
